(19) United States
(12) Patent Application Publication
(10) Pub. No.: US 2011/0077313 A1
(43) Pub. Date: Mar. 31, 2011

(54) FOAMABLE RESIN COMPOSITION AND FOAMED BODY

(75) Inventors: Kei Takahashi, Tokyo (JP); Terumitsu Kotani, Tokyo (JP); Haruki Nishike, Tokyo (JP); Hiroshi Kani, Hokkaido (JP); Katsumi Konno, Hokkaido (JP)

(73) Assignees: SHOWA DENKO K.K., Minato-ku, Tokyo (JP); HOKKAIDO GOVERNMENT, Sapporo-shi, Hokkaido (JP)

(21) Appl. No.: 12/995,944

(22) PCT Filed: May 25, 2009
(86) PCT No.: PCT/JP2009/059534

§ 371 Date: Dec. 2, 2010

(30) Foreign Application Priority Data
Jun. 3, 2008 (JP) 2008-145811

(51) Int. Cl. C08J 9/00

(52) U.S. Cl. 521/84.1

(57) ABSTRACT

A foamable resin composition according to the present invention comprises 10 parts by weight or less, preferably 0.5 to 8 parts by weight of a biodegradable resin and/or polyolefin resin, 10 to 30 parts by weight of water and 0.01 to 5 parts by weight of an inorganic filler, with respect to 100 parts by weight of a modified starch. The modified starch is preferably at least one of oxidized starches, esterified starches, acetylated starches and cationic starches. The foamable resin composition can maintain strength, etc., of the foamed body obtained at a practical level even though the amount of the biodegradable resin and/or polyolefin resin is reduced as much as possible, and has a cost advantage.

### TECHNICAL FIELD

The present invention relates to a foamable resin composition, and more specifically, to a foamable resin composition which is biodegradable and available at low cost, and to a foamed body.

### BACKGROUND ART

Foamable resin molded articles are used for packaging material, cushioning material, thermal insulators, or the like. As raw material for those materials, biodegradable resins or starch have been used instead of polystyrene from the viewpoint of environmental problems and cost.

Reference 1 describes a biodegradable resin foamed body obtained by foaming a composition comprising starch containing water, an ethylene-vinyl acetate copolymer, a surfactant, and the like. Because the composition includes an ethylene-vinyl acetate copolymer, the foamed body is still insufficient as far as the environment is concerned.

Reference 2 describes a biodegradable resin foamed body obtained by foaming a composition comprising starch, polyvinyl alcohol and water. Reference 3 describes a foamed body obtained by foaming a composition comprising a thermoplastic resin, starch and a compatibilizer. Reference 3 also describes an aliphatic polyester as the thermoplastic resin.

### Prior Art Reference

Reference 1: JP 06-87969 A

Reference 2: JP 11-124456 A

Reference 3: JP 2004-2613 A

### SUMMARY OF THE INVENTION

### Problems to be Solved by the Invention

Because the biodegradable resin foamed body described in Reference 2 is mainly composed of starch and polyvinyl alcohol which are biodegradable, the foamed body is sufficient as far as the environment is concerned. Since starch is inexpensive as a material for a foamed body, it is preferable that the amount of starch is increased as much as possible from the viewpoint of cost. Reference 2 prescribes 60 to 80 parts by weight of starch and 10 to 30 parts by weight polyvinyl alcohol. There is still room for cost improvement.

Reference 3 describes that the amount of starch is preferably 50 to 1000 parts by weight with respect to 100 parts by weight of the thermoplastic resin. Further cost improvement is required.

An object of the present invention is to provide a foamable resin composition which is available at low cost and environmentally friendly by reducing the amount of resins as much as possible while maintaining strength, etc., of the foamed body obtained at a practical level.

### Means for Solving the Problems

The inventors of the present application, after conducting intensive studies for a foamable resin composition comprising starch and resins, have found that strength, etc. of the foamed body can be maintained at a practical level by using a modified starch as the starch ingredient and adding an inorganic filler even if the amount of biodegradable resin and/or polyolefin resin is much less than that of the prior foamed body, to complete the present invention.

That is, the present invention provides a foamable resin composition comprising 10 parts by weight or less of a biodegradable resin and/or polyolefin resin, 10 to 30 parts by weight of water and 0.01 to 5 parts by weight of an inorganic filler, with respect to 100 parts by weight of a modified starch.

The foamable resin composition of the present invention preferably comprises 0.5 to 8 parts by weight of the biodegradable resin and/or polyolefin resin, more preferably comprises 2 to 6 parts by weight of the biodegradable resin and/or polyolefin resin.

The biodegradable resin of the present invention is preferably at least one of an aliphatic polyester and polyvinyl alcohol.

The MFR of the biodegradable resin and/or polyolefin resin of the present invention is preferably 5 g/(10 min at 190° C.) or higher.

The modified starch of the present invention is preferably at least one of oxidized starches, esterified starches, acetylated starches and cationic starches.

Further, the present invention provides a foamed body obtained by foaming the foamable resin composition.

The foamed body of the present invention is suitable for expanded foams (discrete foamed bodies).

### EFFECTS OF THE INVENTION

The foamable resin composition according to the present invention comprises an extremely small amount of the biodegradable resin and/or polyolefin resin, i.e. 10 parts by weight or less of the biodegradable resin and/or polyolefin resin with respect to 100 parts by weight of the modified starch, with the remainder mainly being composed of the modified starch. Thus, since the ratio of naturally-derived materials other than inorganic fillers is 90% by weight or more, the foamable resin composition is an environmentally friendly material, and has low carbon dioxide gas emission and a cost advantage. Though prior compositions comprising such large amounts of starch have practical problems, the foamable resin composition according to the present invention can maintain strength, etc. of the foamed body at a practical level by using a modified starch as starch and adding an inorganic filler even after increasing the amount of a starch. The foamed body obtained is particularly suitable for expanded foams.

### MODES FOR CARRYING OUT THE INVENTION

The foamable resin composition according to the present invention comprises 10 parts by weight or less of a biodegradable resin and/or polyolefin resin with respect to 100 parts by weight of a modified starch, with the remainder mainly being composed of the starch ingredient. In the present invention, the term “10 parts by weight or less” includes zero, i.e. a case where there is no biodegradable resin and/or polyolefin resin. The foamable resin composition according to the present invention can significantly reduce the amount of the biodegradable resin and/or polyolefin resin by using a modified starch as the starch ingredient and adding an inorganic filler.

Melt Flow Rate (MFR) of the biodegradable resin and/or polyolefin resin used in the foamable resin composition of the present invention is preferably 5 g/(10 min at 190° C.) or higher, and more preferably 8 g/(10 min at 190° C.) or higher. In addition, the MFR is measured in accordance with JIS K 7210 at a load of 2.16 kg.

The biodegradable resin used in the present invention is preferably an aliphatic polyester and polyvinyl alcohol. These may be mixed to be used.

The aliphatic polyester used in the present invention is synthesized from a polyhydric alcohol such as ethylene glycol, 1,4-butanediol and 1,6-hexanediol, and a polybasic acid such as succinic acid and adipic acid. In addition, examples of the aliphatic polyester used in the present invention also include cyclic aliphatic polyesters obtained by using 1,4-cyclohexane dimethanol as a polyhydric alcohol, and aliphatic aromatic polyesters obtained by using 1,4-butanediol, terephthalic acid and adipic acid.

The saponification value of the polyvinyl alcohol used in the foamable resin composition of the present invention is preferably 90 mole % or more, and more preferably 95 mole % or more.

Examples of the polyolefin resin used in the foamable resin composition of the present invention include polypropylene resin, polyethylene resin, and the like.

The modified starch used in the foamable resin composition of the present invention is a starch obtained by processing natural starches (unmodified starches) such as potato starch, corn starch, sweet potato starch, wheat starch and rice starch. Examples of the processing method include oxidization, esterification, etherification, cross-linking, cationization and the like. Specific examples of the modified starch include oxidized starches such as starch dicarboxylate, esterified starches such as acetylated starch and carboxymethylated starch, cross-linked starches obtained by treating a starch with acetaldehyde or phosphoric acid, and cationic starches obtained by tertiary aminating a starch with 2-dimethylaminoethyl chloride. Of those, cationic starches are preferred.

The foamable resin composition according to the present invention comprises an inorganic filler. The inorganic filler plays a role in improving the strength of the foamed body by making foamed cells very small. Specific examples of the inorganic filler include titanium oxide, talc, calcium carbonate, egg shell and silica.

The foamable resin composition according to the present invention can be obtained by mixing the modified starch, the biodegradable resin and/or polyolefin resin, the inorganic filler and water. The mixing ratio is 10 parts by weight or less of the biodegradable resin and/or polyolefin resin, 0.01 to 5 parts by weight of the inorganic filler and 10 to 30 parts by weight of water, with respect to 100 parts by weight of the modified starch.

In order to reduce the cost, the amount of the biodegradable resin and/or polyolefin resin is determined to be 10 parts by weight or less, with respect to 100 parts by weight of the modified starch. The amount is preferably 0.5 to 8 parts by weight, and more preferably 2 to 6 parts by weight in terms of the cost and properties.

The inorganic filler can improve the strength of the foamed body by making foamed cells very small. Therefore, 0.01 parts by weight or more of water is needed with respect to 100 parts by weight of the modified starch. On the other hand, since an excess amount of the inorganic filler increases the specific gravity of the foamed body, the amount of the inorganic filler is determined to be up to 5 parts by weight, with 0.02 to 3 parts by weight preferred. The particle size of the inorganic filler is not particularly limited, and a particle size commonly used for a resin composition may be applied.

The water plays a role in foaming the foamable resin composition. In order to obtain a favorable foamed body, 10 parts by weight or more of water is needed with respect to 100 parts by weight of the modified starch. Since an excess amount of water can not raise the expansion ratio as it breaks the foamed cells, the amount of water is determined to be up to 30 parts by weight.

In the present invention, the amount of water is the sum of added water and water included in the modified starch. Therefore, 100 parts by weight of the modified starch means a weight excluding the water included in the modified starch.

In addition, coloring agents, repellents, cross-linking materials, fungicides, antimicrobial agents, surfactants, polyethylene glycol, glycerol, water-absorbing polymers, flame retardants, fragrances, weather-resistant agents and the like may be added to the foamable resin composition according to the present invention as required.

In the present invention, the method of mixing the modified starch, biodegradable resin and/or polyolefin resin, inorganic starch and water is not particularly limited.

The foamed body can be generally produced as follows: a modified starch, a biodegradable resin and/or polyolefin resin, an inorganic starch and water are preliminarily mixed with a Henschel mixer or the like; the mixture is then heated and melted under pressure to be extruded while being foamed from a die having a desired shape with an extruder, to directly obtain the foamed body; and the foamed body is cut into expanded foams. In addition, the foamed body can also be produced as follows: a modified starch, a biodegradable resin and/or polyolefin resin, an inorganic starch and water are mixed with a Henschel mixer or the like; the mixture is then heated and melted under pressure in conditions where the foaming is not caused by an extruder to obtain a strand from a die; the strand is cut into pellets; the pellets are loaded, for example, into an extruder at a different place; and the pellets are heated at high temperature and melted under pressure to be extruded from a die having a desired shape, to thereby the foamed body can be obtained. Further, the foamed body can also be produced as follows: a modified starch, a biodegradable resin and/or polyolefin resin, and an inorganic starch are mixed with a Henschel mixer or the like; water is charged into an extruder when the mixture is kneaded with the extruder; and the mixture is extruded while being foamed from a die having a desired shape, to thereby the foamed body can be obtained. Thus, the foamable resin composition of the present invention includes, in addition to a composition to which water is preliminarily added, a composition to which water is added while kneading is performed in an extruder. Moreover, the following can be performed: after pellets blended with a component other than water are obtained, the pellets are impregnated with water, and the resultant is foamed to become foamed pellets; or pellets obtained under the conditions in which the pellets containing water are not foamed or pellets obtained by being impregnated with water later are formed into various foamed molded articles by using a mold. The foamable resin composition of the present invention thus also includes a composition obtained by impregnating pellets with water later as described above. The foamable resin composition of the present invention can be formed into a foamed molded article, and can be suitably used as a cushioning material after being formed into an expanded foam.

### EXAMPLES

Hereinafter, the present invention will be specifically described by way of examples, and the present invention is not limited to the examples.

The following raw materials were used in the examples.

### <Starch>

Cationic starch (manufactured by Oji Cornstarch Co., Ltd., product name: Ace K100, moisture content: 10% by weight)

Oxidized starch (manufactured by Oji Cornstarch Co., Ltd., product name: Ace A, moisture content: 9% by weight)

Esterified starch (manufactured by Oji Cornstarch Co., Ltd., product name: Ace P130, moisture content: about 9.5% by weight)

Acetylated starch (manufactured by Oji Cornstarch Co., Ltd., product name: Ace OSA1100, moisture content: about 9% by weight)

Raw corn starch (manufactured by Oji Cornstarch Co., Ltd., product name: Raw Corn Starch, moisture content: about 8.5% by weight)

### <Biodegradable Resin>

Aliphatic polyester (manufactured by SHOWA HIGHPOLYMER Co., Ltd., product name: BIONOLLE #1010, MFR: 10 g/(10 min at 190° C.))

Polyvinyl alcohol (manufactured by Nippon Synthetic Chemical Industry, Co., Ltd., product name: GOHSENOL NM-11)

### <Polyolefin Resin>

Polypropylene (manufactured by SunAllomer Ltd., product name: PM600A, MFR: 7.5 g/(10 min at 190° C.))

### <Inorganic Filler>

Talc (the average particle diameter measured by a laser method is about 10 μm)

The above-mentioned raw materials were mixed by using a Henschel mixer in the ratio described in Tables 1 and 2, the mixture was extruded while being foamed from a co-rotating twin screw extruder, and the foamed body was obtained. Here, the cylinder temperature was set to 190° C. The foamed body obtained was cut to be a cylindrical foamed molded article. The amount of water in the tables is the sum of added water and water included in the starch.

The evaluation was conducted in accordance with the following method. A cylindrical foamed molded article which was flexible, was flattened by being subjected to a load, and restored to its original shape after releasing the load, and so it was evaluated as ⊚. A cylindrical foamed molded article which was slightly brittle, was flattened by being subjected to the load, and restored to its original shape after releasing the load, and so it was evaluated as ◯. A cylindrical foamed molded article which was brittle, was flattened by being subjected to a load, and moderately restored to its original shape after releasing the load, and so it was evaluated as Δ. A cylindrical foamed molded article whose foamed cells were very large, was subjected to a load and crushed, and so it was evaluated as ▴.

TABLE 1

| | Example | | | | | |
|---|---|---|---|---|---|---|
| | 1 | 2 | 3 | 4 | 5 | 6 |
| Cationic starch | 100 | 100 | 100 | | | |
| [parts by weight] | | | | | | |
| Oxidized starch | | | | 100 | | |
| [parts by weight] | | | | | | |
| Esterified starch | | | | | 100 | |
| [parts by weight] | | | | | | |
| Acetylated starch | | | | | | 100 |
| [parts by weight] | | | | | | |
| Raw corn starch | | | | | | |
| [parts by weight] | | | | | | |
| Aliphatic polyester | 9 | 5 | 2 | 8 | 8 | 8 |
| [parts by weight] | | | | | | |
| Polyvinyl alcohol | | | | | | |
| [parts by weight] | | | | | | |
| Polypropylene | | | | | | |
| [parts by weight] | | | | | | |
| Talc [parts by weight] | 1 | 1.5 | 0.8 | 1.2 | 2 | 1.5 |
| Water [parts by weight] | 15 | 15 | 15 | 15 | 15 | 15 |
| Evaluation | ⊚ | ⊚ | ⊚ | ◯ | ◯ | ◯ |

TABLE 2

| | | | | Comparative | |
|---|---|---|---|---|---|
| | Example | | | Example | |
| | 7 | 8 | 9 | 1 | 2 |
| Cationic starch [parts by weight] | | 100 | 100 | | |
| Oxidized starch [parts by weight] | | | | | 100 |
| Esterified starch [parts by weight] | 100 | | | | |
| Acetylated starch [parts by weight] | | | | | |
| Raw corn starch [parts by weight] | | | | 100 | |
| Aliphatic polyester [parts by weight] | | | | 10 | 5 |
| Polyvinyl alcohol [parts by weight] | 9 | | | | |
| Polypropylene [parts by weight] | | 7 | | | |
| Talc [parts by weight] | 1.5 | 1.5 | 1.5 | 1.5 | 0 |
| Water [parts by weight] | 15 | 15 | 15 | 15 | 15 |
| Evaluation | Δ | ◯ | Δ | Δ | ▴ |

The foamable resin composition of the present invention can be formed into a product that is environmentally friendly, since most of the composition is biodegradable. Also, the foamable resin composition of the present invention is suitable for cushioning material, packaging material, thermal insulators, or the like, since the composition is available at low cost due to very high starch content.

1. A foamable resin composition comprising 10 parts by weight or less of a biodegradable resin and/or polyolefin resin, 10 to 30 parts by weight of water and 0.01 to 5 parts by weight of an inorganic filler, with respect to 100 parts by weight of a modified starch.

2. A foamable resin composition according to claim 1, wherein 0.5 to 8 parts by weight of the biodegradable resin and/or polyolefin resin is included with respect to 100 parts by weight of the modified starch.

3. A foamable resin composition according to claim 1, wherein 2 to 6 parts by weight of the biodegradable resin and/or polyolefin resin is included with respect to 100 parts by weight of the modified starch.

4. A foamable resin composition according to claim 1, wherein the biodegradable resin is at least one of an aliphatic polyester and polyvinyl alcohol.

5. A foamable resin composition according to claim 1, wherein MFR of the biodegradable resin and/or polyolefin resin is 5 g/(10 min at 190° C.) or higher.

6. A foamable resin composition according to claim 1, wherein the modified starch is at least one of oxidized starches, esterified starches, acetylated starches and cationic starches.

7. A foamed body obtained by foaming the foamable resin composition according to claim 1.

8. A foamed body according to claim 7, wherein the foamed body is an expanded foam.
